(19) United States
(12) Patent Application Publication
(10) Pub. No.: US 2025/0019538 A1
(43) Pub. Date: Jan. 16, 2025

(54) BIODEGRADABLE POLYMER COMPOSITION WITH PROCESSING AID

(71) Applicant: KANEKA AMERICAS HOLDING, INC., Pasadena, TX (US)

(72) Inventors: Shusuke Yoshihara, Pasadena, TX (US); Greg Zientek, Pasadena, TX (US); Frank Muchna, Pasadena, TX (US)

(73) Assignee: KANEKA AMERICAS HOLDING, INC., Pasadena, TX (US)

(21) Appl. No.: 18/712,186

(22) PCT Filed: Nov. 17, 2022
(86) PCT No.: PCT/US2022/050219

§ 371 Date: May 21, 2024

Related U.S. Application Data
(60) Provisional application No. 63/282,394, filed on Nov. 23, 2021.

(51) Int. Cl. C08L 67/04; C08J 3/00; C08L 1/12

(52) U.S. Cl. CPC C08L 67/04; C08J 3/005; C08L 1/12; C08J 2301/12; C08J 2367/04; C08J 2433/10; C08J 2467/02; C08L 2201/06; C08L 2205/03; C08L 2205/06

(57) ABSTRACT

A biodegradable polymer composition includes a biodegradable matrix polymer, and 0.1 to 5 wt. % of a processing aid having a weight average molecular weight of at least 20,000 g/mol. The processing aid is a reaction product of an acrylate monomer and, optionally, at least one copolymerizable monomer. The amount of the acrylate monomer in the processing aid ranges from 50 wt % to 100 wt %, and the amount of the copolymerizable monomer in the processing aid ranges from 0 wt % to 50 wt %. A biodegradable polymer article includes the biodegradable polymer composition. A method includes mixing a biodegradable matrix polymer with 0.1 to 5 wt. % of a processing aid, having a weight average molecular weight of at least 20,000 g/mol above melting temperatures of the biodegradable matrix polymer and the processing aid, to produce a biodegradable polymer composition.

### BACKGROUND

Plastic materials have found their applications and uses in virtually every aspect of the modern society, owing to their versatility, cost benefit, and ease of mass production. However, discarded plastics are a major environmental concern because conventional plastic materials are not biodegradable, (meaning not capable of being decomposed by bacteria or other living organisms), and as a result many discarded plastics remain in the environment as pollutants semi-permanently.

To combat such environmental issues, numerous biodegradable polymer compositions have been developed and commercialized. However, the use of biodegradable plastics only amounts to a small percentage of the total production and consumption quantity of plastic products. One of the reasons for the small percentage is that biodegradable polymer compositions often possess inferior properties when compared to their conventional polymer counterparts. Accordingly, there exists a need for continuing improvement of the biodegradable polymer composition properties.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In one aspect, embodiments disclosed herein relate to a biodegradable polymer composition, including a biodegradable matrix polymer and 0.1 to 5 wt. % of a processing aid having a weight average molecular weight (Mw) of at least 20,000 g/mol. The processing aid is a reaction product of an acrylate monomer and optionally, at least one copolymerizable monomer. The amount of the acrylate monomer in the processing aid ranges from 50 wt % to 100 wt %, and the amount of the at least one copolymerizable monomer in the processing aid ranges from 0 wt % to 50 wt %.

In another aspect, embodiments disclosed herein relate to a biodegradable polymer article comprising the biodegradable polymer composition.

In yet another aspect, embodiments disclosed herein relate to a method which includes mixing a biodegradable matrix polymer with 0.1 to 5 wt. % of a processing aid having a Mw of at least 20,000 g/mol, at a temperature above the melting temperatures of both the biodegradable matrix polymer and the processing aid, to produce a biodegradable polymer composition. The processing aid is a reaction product of an acrylate monomer and, optionally, at least one copolymerizable monomer. The amount of the acrylate monomer in the processing aid ranges from 50 wt % to 100 wt %, and the amount of the at least one copolymerizable monomer in the processing aid ranges from 0 wt % to 50 wt %.

Other aspects and advantages of the claimed subject matter will be apparent from the following description and the appended claims.

### BRIEF DESCRIPTION OF THE DRAWINGS

FIG. 1 illustrates a schematic molecular structure of a biodegradable polymer composition produced by reacting a biodegradable polyester with a processing aid in accordance with one or more embodiments.

FIG. 2 is a plot of complex viscosity curves of EXAMPLE 3 and REFERENCE EXAMPLE 2 measured at a temperature of 210° C. and angular frequency of 0.1 to 500 rad/s using a parallel plate rheometer with a plate diameter of 25 mm.

FIG. 3 is a plot of tangent delta (tan δ) curves of EXAMPLE 3 and REFERENCE EXAMPLE 2 measured at a temperature of 210° C. and angular frequency of 0.1 to 500 rad/s using a parallel plate rheometer with a plate diameter of 25 mm.

FIG. 4 is a plot of tan δ curves of EXAMPLE 4 and REFERENCE EXAMPLE 2 measured at a temperature of 210° C. and angular frequency of 0.1 to 500 rad/s using a parallel plate rheometer with a plate diameter of 25 mm.

FIG. 5 is a plot of complex viscosity curves of EXAMPLE 6 and REFERENCE EXAMPLE 3 measured at a temperature of 160° C. and angular frequency of 0.1 to 500 rad/s using a parallel plate rheometer with a plate diameter of 25 mm.

FIG. 6 is a plot of tan δ curves of EXAMPLE 6 and REFERENCE EXAMPLE 3 measured at a temperature of 160° C. and angular frequency of 0.1 to 500 rad/s using a parallel plate rheometer with a plate diameter of 25 mm.

### DETAILED DESCRIPTION

The present disclosure generally relates to a biodegradable polymer composition comprising a processing aid. The processing aid, which is a reaction product of an acrylate monomer and, optionally, one or more copolymerizable monomers, improves properties of the biodegradable polymer composition (such as maximum tensile elongation and melt strength) without adversely affecting other properties (such as optical properties and viscosity) of the biodegradable polymer composition.

In one aspect, embodiments disclosed herein relate to a biodegradable polymer composition comprising a biodegradable matrix polymer and 0.1 to 5 wt. % of a processing aid having a weight average molecular weight (Mw) of at least 20,000 g/mol, wherein the processing aid is a reaction product of an acrylate monomer and, optionally, at least one copolymerizable monomer.

### Biodegradable Matrix Polymer

In the present disclosure, a biodegradable matrix polymer refers to a polymer that is deteriorated or degraded by a bacterial decomposition process into byproducts such as gases, water, biomass, and inorganic salts, typically after the polymer's intended use. The biodegradable matrix polymer may be from a natural source or artificially produced. There is no limitation on the types of biodegradable matrix polymer that may be used, provided the polymer is biodegradable.

In one or more embodiments, the biodegradable polymer composition may comprise a biodegradable matrix polymer in an amount of about 50 wt % to 99.9 wt %. For example, the amount of the biodegradable matrix polymer in the biodegradable polymer composition may range from a lower limit selected from any one of 50, 55, 60, 65, 70, 75, and 80 wt %, to an upper limit selected from any one of 85, 90, 95, 96, 97, 98, 99, 99.5, and 99.9 wt %, where any lower limit may be paired with any upper limit.

In one or more embodiments, the biodegradable matrix polymer may be cellulose. Examples of cellulose may include, but are not limited to, organic acid esters of cellulose including cellulose acetate, cellulose acetate propionate, cellulose acetate butyrate, cellulose acetate trimellitate, hydroxypropylmethyl cellulose phthalate, or a combination thereof.

In one or more embodiments, the biodegradable matrix polymer may be a biodegradable polyester. Examples of the biodegradable polyester may include, but are not limited to, poly lactic acid (PLA), polybutylene adipate terephthalate (PBAT) polyhydroxyalkanoates (PHA) including poly(3-hydroxybutyrate-co-3-hydroxyhexanoate) (PHBH) such as Green Planet™ biodegradable polymer available from Kaneka Corporation, or a combination thereof. The combination may be in a form of a mixture or a form of a co-polymer or a ter-polymer.

In one or more embodiments, the biodegradable matrix polymer may be any polymer that is biodegradable. Such biodegradable polymers may include, but are not limited to, polybutylene succinate (PBS), polycaprolactone (PCL) poly(glycolic acid) (PGA), poly(lactic-co-glycolic acid) (PLGA), poly(ethylene adipate) (PEA), poly(p-dioxanone) (PDS), and their copolymers and a combination thereof. In some embodiments, these biodegradable polymers may be combined with cellulose and/or biodegradable polyester.

### Processing Aid

As noted above, in one or more embodiments, the biodegradable polymer composition includes a processing aid which is a reaction product of an acrylate monomer, and optionally, one or more copolymerizable monomers.

In one or more embodiments, the biodegradable polymer composition may comprise the processing aid in an amount of about 0.1 wt % to 5.0 wt %. For example, the amount of the processing aid in the biodegradable polymer composition may range from a lower limit selected from any one of 0.1, 0.2, 0.3, 0.4, and 0.5 wt % to an upper limit selected from any one of 0.6, 0.7, 0.8, 0.9, 1, 1.5, 2.0, 3.0, 4.0, and 5.0 wt %, where any lower limit may be paired with any upper limit. It is noted that a biodegradable polymer composition containing 1 wt % or less of the processing aid, may be certified as biodegradable without additional biodegradation testing.

In one or more embodiments, examples of the acrylate monomer may include, for example, methacrylates having an alkyl group with 1 to 22 carbon atoms, such as methyl methacrylate, ethyl methacrylate, propyl methacrylate, butyl methacrylate, 2-ethylhexyl methacrylate, octyl methacrylate, dodecyl methacrylate, stearyl methacrylate, and behenyl methacrylate; alkyl acrylates containing an alkyl group having 1 to 8 carbon atoms such as 2-ethyl hexyl acrylate, butyl acrylate, ethyl acrylate and methyl acrylate; and acrylates having an alkyl group with 1 to 22 carbon atoms and an alkoxy group. These acrylate monomers can be used alone or in combination. The number of carbon atoms of the alkyl group in the acrylate is not necessarily limited, but, for example, if the number of carbon atoms is more than 22, the polymerizability may be deteriorated, and thus acrylates having an alkyl group with 22 or fewer carbon atoms may result in better polymerization. Acrylates having an alkyl group with 1 to 8 carbon atoms may be particularly useful because they have excellent compatibility with a polyester resin. Methyl methacrylate is preferably used because of the high glass transition temperature and its miscibility with celluloses and biodegradable polyesters. In the present disclosure, unless indicated otherwise, (meth)acrylate refers to acrylate or methacrylate.

In one or more embodiments, the amount of acrylate monomer reacted into the processing aid may range from about 50 to 100 wt % based on the total amount of the processing aid, such as a lower limit selected from any one of 50, 55, 60, 65, 70, 75, and 80 wt %, to an upper limit selected from any one of 85, 90, 95, 96, 97, 98, 99, and 100 wt %, where any lower limit may be paired with any upper limit.

As noted above, the processing aid may optionally include one or more copolymerizable monomers. The copolymerizable monomer may be any monomer which is capable of co-reacting with the previously described acrylate monomer. Thus, the copolymerizable monomer includes at least one reactive group.

A reactive group, or a reactive functional group, refers to a molecular structure or a group capable of reacting to produce a chemical bond to another molecular structure.

In one or more embodiments, the copolymerizable monomer may be a “functional monomer” which contains at least two reactive groups (or functionality), such that one reactive group of the copolymerizable monomer reacts with the acrylate monomer to produce the processing aid, and the rest of the reactive groups remain unreacted.

In one or more embodiments, the functional monomer may contain reactive functional groups capable of further reacting with the biodegradable matrix polymer, when combined under specific conditions, such as under an elevated temperature condition, which may include a temperature of at least 30, 40, 50, 60, 70, 80, 90, 100, 120, 140, 160, 180, or 200° C. A processing aid produced from a reactive functional monomer may provide improved properties, such as maximum tensile elongation and melt strength, when mixed and reacted with the biodegradable matrix polymer. Such improved properties may be due to additional crosslinking within the molecular structure of the biodegradable polymer composition.

In one or more embodiments, the functional monomer may contain functional groups that do not react with the biodegradable matrix polymer but are capable of reacting with molecular structures not incorporated into the biodegradable matrix polymer. It is also envisioned that the functional monomer may contain a combination of functional groups that react with the biodegradable matrix polymer and functional groups that do not.

In one or more embodiments, the functional monomer may include reactive functional groups such as an epoxy group, a carboxyl group, an isocyanate group, an acid anhydride group, an aziridine group, a urethane group, and/or an acyl chloride group. In one or more embodiments, the functional monomer may include functional groups that do not react with the biodegradable matrix polymer, such as a hydroxy group. Examples of the functional monomer may include monomers such as (meth)acrylate containing an epoxy group, alkyl (meth)acrylate containing a hydroxy group, and (meth)acrylate containing a carboxyl group. Other suitable monomers may have a functional group such as an isocyanate group, an acid anhydride group, and an acyl chloride group. For example, the functional monomers may be acrylates having an alkyl group with 1 to 22 carbon atoms and a hydroxyl group such as 2-hydroxyethyl acrylate and 4-hydroxybutyl acrylate, or methacrylates having an epoxy group such as glycidyl methacrylates. In particular, from the viewpoint of favorable reactivity, (meth)acrylate containing an epoxy group may be used.

Examples of the (meth)acrylate containing a hydroxy group include hydroxyethyl methacrylate, hydroxyethyl acrylate, hydroxypropyl methacrylate, and hydroxypropyl acrylate. Examples of the (meth)acrylate containing a carboxyl group include methacrylic acid and acrylic acid.

In one or more embodiments, the copolymerizable monomer only contains one reactive group, such that once the copolymerizable monomer is reacted with the acrylate monomer, the portion of the processing aid formed by the copolymerizable monomer does not contain a reactive functional group.

Additional examples of the copolymerizable monomer may include, but are not limited to, a (meth)acrylate monomer, styrene monomer, alpha methyl styrene monomer, acrylonitrile monomer, vinyl cyanide monomer, vinyl acetate monomer, and (meth)acrylic acid monomer.

In one or more embodiments, the amount of copolymerizable monomer that reacts to form the processing aid may range from about 0 to 50 wt % of the total amount of the processing aid, such as a lower limit selected from any one of 0, 1, 2, 3, 4, 5, 10, 15, and 20 wt %, to an upper limit selected from any one of 30, 35, 40, 45, and 50 wt %, where any lower limit may be paired with any upper limit.

In one or more particular embodiments, the copolymerizable monomer may be glycidyl methacrylate. In such embodiments, the amount of glycidyl methacrylate that reacts to form the processing aid may range from about 1 to 30 wt %, such as a lower limit selected from any one of 1, 2, 3, 4, 5, 10, 15, and 20 wt % to an upper limit selected from any one of 5, 10, 15, 20, 25, 26, 27, 28, 29, and 30 wt %, where any lower limit may be paired with any mathematically compatible upper limit.

In one or more embodiments, the processing aid may have a weight average molecular weight (Mw) of at least 20,000 g/mol. For example, the processing aid may have a Mw ranging from about 20,000 to 6,000,000 g/mol, such as a lower limit selected from any one of 20,000, 50,000, 100,000, 150,000, and 200,000 g/mol, to an upper limit selected from any one of 300,000, 500,000, 1,000,000, 3,000,000, 4,000,000, 5,000,000 and 6,000,000 g/mol, where any lower limit may be paired with any upper limit.

In one or more embodiments, the processing aid may be produced by reacting an acrylate monomer and a copolymerizable monomer having an epoxy functional group, and, as a result, the processing aid may have unreacted epoxy groups capable of reacting with another compound, such as but not limited to the biodegradable matrix polymer. The amount of unreacted epoxy groups present in the processing aid may be characterized by an epoxy equivalent weight (EEW). EEW represents the amount of a material, such as a polymer, which contains one mole of epoxy group, and generally has the unit of grams/equivalent (g/eq). In one or more embodiments, the processing aid may have an EEW ranging from about 400 to 15,000 g/eq, such as a lower limit selected from any one of 400, 450, 500, 600, 700, 800, 900, and 1,000 g/eq, to an upper limit of 10,000, 11,000, 12,000, 13,000, 14,000, and 15,000 g/eq, where any lower limit may be paired with any upper limit. If the EEW is less than 400, the cross-linked density may become high, leading to gelation and high haze.

In one or more embodiments, the processing aid may have a refractive index (RI) ranging from 1.45 to 1.50. It is measured, for example, by ABBE mark III refractometer, according to ASTM D542. Such a processing aid can maintain the clarity of the most biodegradable polymers composition because the RI of the processing aid is similar to the RI of the biodegradable matrix polymer.

### Additives

In one or more embodiments, the biodegradable polymer composition may also include conventionally known additives, for example, antioxidants; anti-dripping agents; polymer processing aids; flame retardants; impact modifiers; melt flow-improving agents; plasticizers; lubricants; ultraviolet absorbers; pigments; fiber reinforcing agents; glass fibers; fillers, such as talc, mica, calcium carbonate, oxides of titanium, zinc oxide nano-particles, layer silicate, metallic micro-particles, and carbon nanotubes; polymer lubricants; and mold-release agents.

In one or more embodiments, the plasticizer which may be incorporated into the biodegradable polymer composition may comprise ethylene glycol (EG), propylene glycol (PG), diethylene glycol (DEG), triethylene glycol (TEG), tetraethylene glycol and polyethylene glycol (PEG), di(2-ethylhexyl) phthalate (DEHP), dioctyl phthalate (DOP), di-isononyl phthalate (DINP), di-isodecyl phthalate (DIDP), di-ethyl phthalate (DEP), di-butyl phthalate (DBP) and butyl benzyl phthalate (BBP), triethyl citrate (TEC), acetyl triethyl citrate (TEA), tributyl citrate (TBC), and natural-based plasticizers like epoxidized triglyceride vegetable oils from soybean oil, linseed oil, castor-oil, sunflower oil, and fatty acid esters.

### Biodegradable Polymer Composition-Properties

In one or more embodiments, the biodegradable polymer composition may have a yellowing index (YI) ranging from 0 to 30 when the thickness of the composition is 3 mm, or from 0 to 10 when the thickness is less than 1 mm. YI is a number determined from spectrophotometric data to characterize the change of a material from clear or white to yellow. YI of a material may be determined by using a spectrophotometer, such as UltraScan VIS from HunterLab, and tested according to ASTM E313.

In one or more embodiments, the biodegradable polymer composition may have a haze value of about 50% or lower according to ASTM D1003 when the specimen thickness is 3 m. The haze value indicates the amount of light scattered in the material in question as the light passes through the material, and represents the optical clarity of the material. The value depends on the thickness of the material. For example, the biodegradable polymer composition may have a haze value of at most 50%, at most 40%, at most 30%, at most 20%, or at most 10%, according to ASTM D1003, for a specimen thickness of 3 mm.

In one or more embodiments, the biodegradable polymer composition may have an improved melt strength as compared to a biodegradable without the processing aid described herein. A melt strength of a polymer refers to a measure of the resistance of a polymer melt to extensional deformation. The melt strength is related to the processability of a polymer. For example, an increase in melt strength may result in sag reduction of a polymeric article, such as a sheet or a rod. Sagging is said to have occurred when the polymeric article “stretches” or deforms due to the gravitational force as it exits processing equipment, such as an extruder, resulting in a deformed polymeric article. Reduction of sag is desirable from a viewpoint of precise and consistent production of a polymeric article.

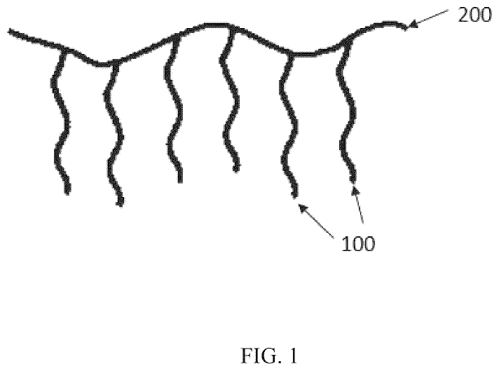

FIG. 1 is an exemplary schematic diagram of the molecular structure of the biodegradable polymer composition produced by reacting a biodegradable matrix polymer, such as PLA, with a processing aid. In some embodiments, the biodegradable polymer composition may have a “comb” structure, as shown in FIG. 1, with a processing aid molecule 200 as a backbone and biodegradable matrix polymer molecules 100 as “fingers.” The comb structure may increase the entanglement between the biodegradable matrix polymers attached to the processing aid, and may result in an increase of the melt strength.

The melt strength of a polymer may be characterized by a tangent delta (tan δ) value of a molten polymer. Tan δ represents the viscoelastic behavior of a substance and is also referred to as a loss factor. Tan δ is defined as a ratio of a loss modulus (E″ or G″) to a storage modulus (E′ or G′) of a liquid substance, such as molten polymer, where the loss modulus represents the viscous behavior of a substance, while the storage modulus represents the elastic behavior of the substance. Tan δ of a molten polymer may be obtained by using a parallel plate rheometer.

A reduction in tan δ value corresponds to an increase in the melt strength and reduction in sag characteristics, as the material becomes less viscoelastic and more elastic. In one or more embodiments, the biodegradable PLA composition may have a tan δ value of 80 or less at the peak maximum, when the tan δ value is measured by a parallel plate rheometer having a plate diameter of 25 mm, at a temperature of 210° C. and an angular frequency of 0.1 rad/s to 500 rad/s. The biodegradable PHBH composition may have a tan δ value of 5 or less at the peak maximum, when the tan δ value is measured by a parallel plate rheometer having a plate diameter of 25 mm, at a temperature of 160° C. and an angular frequency of 0.1 rad/s to 500 rad/s. The peak maximum is defined as the maximum value of tan δ obtained from a single measurement where tan δ is measured by varying the angular frequency at a specific temperature, as described above.

In one or more embodiments, the biodegradable polymer composition may have a tan δ reduction percentage (%) of at least about 10%, such as at least 10%, 15%, 20%, 25%, 30%, 40%, or 50%. The tan δ reduction % is defined as the ratio of the difference between the tan δ of the biodegradable polymer composition at the peak maximum (tan δ_{P}) and the tan δ of a “baseline” polymer composition at the same angular frequency (tan δ_{B}). The tan δ reduction % may be expressed as follows:

$$tan δ reduction \% = \frac{tan {δ}_{B} - tan {δ}_{P}}{tan {δ}_{P}} \times 100$$

where tan δ_{B} is the tan δ of the baseline polymer composition, and tan Op is the tan δ of the biodegradable polymer composition

The baseline polymer composition refers to a polymer composition having the same components and the same amount (based on parts) of components as the biodegradable polymer composition, except that the processing aid is not added.

In order to obtain the tan δ reduction %, the tan δ values of the biodegradable polymer composition and the baseline polymer compositions are measured under the same conditions, including the test temperature and size of the parallel plate, and tan δ values at the same angular frequency are used to obtain the tan δ reduction %.

The percentage (%) change of the complex viscosity is defined as the ratio of the difference between the complex viscosity of molten biodegradable polymer composition (η*_{P}) and the complex viscosity of the molten baseline polymer composition (η*_{B}). The % change of the complex viscosity may be expressed as follows:

$$\% chnage of a complex viscosity = \frac{( {η}_{P}^{*} - {η}_{B}^{*} )}{{η}_{P}^{*}} \times 100$$

In one or more embodiments, the biodegradable PLA composition may have a % change of a complex viscosity of 70% or less, when measured by a parallel plate rheometer, having a plate diameter of 25 mm, at a temperature of 210° C. and an angular frequency of 0.1 rad/s to 500 rad/s. The biodegradable PHBH composition may have a % change of a complex viscosity of 70% or less, when measured by a parallel plate rheometer, having a plate diameter of 25 mm, at a temperature of 160° C. and an angular frequency of 0.1 rad/s to 500 rad/s.

### Biodegradable Polymer Articles

In another aspect, embodiments disclosed herein relate to a biodegradable polymer article comprising the biodegradable polymer composition. There is no limitation on the types of biodegradable polymer articles that may be produced from the biodegradable composition. In some embodiments, the biodegradable polymer article may include, but is not limited to, a sheet, a film, a foam, a rod, a profile sheet, a co-extruded sheet, a profile capstock, and a co-extruded capstock.

### Method for Producing Biodegradable Polymer Articles

In yet another aspect, embodiments disclosed herein related to a method for producing a biodegradable polymer article.

In one or more embodiments, the method may include mixing a biodegradable matrix polymer and a processing aid to produce a biodegradable polymer composition, where the biodegradable matrix polymer and the processing aid may have structures, compositions, and properties as described in the previous sections. In one or more embodiments, biodegradable matrix polymer and the processing aid may be mixed above the melting temperatures of the biodegradable matrix polymer and the processing aid. The melting temperature of the biodegradable matrix polymer and the processing aid may be determined in accordance with various test methods, such as ASTM D3418.

The mixing may be conducted by any suitable mixing method. In one or more embodiments, conventional processes including extrusion, co-extrusion, high-shear mixing, and the like may be used. Equipment including a single-screw extruder, twin-screw extruder, banbury mixer, or heating roller may be suitable for mixing the biodegradable matrix polymer and the processing aid. It is also envisioned that the biodegradable matrix polymer and the processing aid may be mixed by dissolving the components in a solvent.

In one or more embodiments, the mixing may be conducted at a temperature ranging from a lower limit selected from any one of 50, 60, 70, 80, 90, and 100° C. to an upper limit selected from any one of 150, 160, 170, 180, 190, 200, 210, 220, 230, 240, 250, and 300° C., where any lower limit may be paired with any upper limit. As noted above, the mixing temperature may be selected based on the melting points of the biodegradable matrix polymer and the processing aid.

The mixing may be conducted for a time suitable for the polymerization reaction to be complete. The reaction time is typically at least one minute.

In one or more embodiments, the method may further include forming a biodegradable polymer article from the biodegradable polymer composition. Forming the article may be performed by any conventional processes including extrusion, co-extrusion, injection molding, compression molding, film extrusion, blow molding, foam extrusion, rotational molding, calendaring, fiber spinning, and the like. In one or more particular embodiments, the forming may be performed by at least one process selected from the group consisting of extrusion, co-extrusion, injection molding, compression molding, film extrusion, and blow molding.

In one or more embodiments, the mixing process and the forming process may be conducted using a single process. For example, an extruder containing a die may be used to mix the biodegradable matrix polymer and the processing aid, and an article, such as a sheet or a rod, may be extruded through the die of the extruder.

In one or more embodiments, the mixing process and the forming process may be conducted separately using the same or different processes. For example, an extruder may be used to mix the biodegradable matrix polymer and the processing aid to produce a biodegradable polymer composition in an intermediate form such as pellets, flakes, and powders. The biodegradable polymer composition in the intermediate form may be processed further by a process such as injection molding, extruder, blow molder, or film extrusion to produce a biodegradable polymer article.

In one or more embodiments, the forming of a biodegradable polymer article may include using a biodegradable polymer article as an intermediate article and further forming the intermediate article to produce a final biodegradable polymer article that is different from the intermediate article. An example of such intermediate article may include a sheet or a rod, and the intermediate article may be formed into a final article by a process such as compression molding.

### EXAMPLES

The following examples are provided to illustrate embodiments of the present disclosure. The Examples are not intended to limit the scope of the present invention, and they should not be so interpreted.

### Materials

Cellulose Acetate having a number average molecular weight of 30,000 was obtained from Sigma Aldrich. Triethyl citrate (TEC) as a plasticizer was obtained from Sigma Aldrich. Polylactic acid (PLA), Ingeo 3052D was obtained from Nature Works. PHBH, X071, was provided by Kaneka Corporation.

### Processing Aid 1

An 8-liter reactor equipped with a stirrer was charged with 0.5 part of sodium dioctyl sulfosuccinate (emulsifier) and 0.1 part of potassium persulfate (polymerization initiator) that were previously dissolved in water, and thereto was further added water, so that the total amount of water became 200 parts. Oxygen was removed by introducing nitrogen gas into the reactor and it was heated to 70° C. with stirring. A monomer mixture (A) of 72 parts of methyl methacrylate (MMA) and 8 parts of glycidyl methacrylate (GMA) was added dropwise at a rate of about 16 parts per hour. After the completion of the addition, a monomer mixture (B) of 18 parts of MMA and 2 parts of GMA was added dropwise at a rate of about 16 parts per hour. After the completion of the addition, the temperature was maintained at 70° C. for 60 minutes and then cooled to yield a latex.

The polymerization conversion was 99.5%. The obtained latex was coagulated with an aqueous solution of calcium chloride, heat-treated by raising the temperature up to 95° C., and dehydrated by means of a centrifugal dehydrator to give a dehydrated cake of a polymer. The dehydrated cake was washed with water in an amount almost the same weight as that of the polymer and then dried at 50° C. for 24 hours by a concurrent flow drier to yield the PROCESSING AID 1 in the form of a white powder. The weight average molecular weight (Mw) was 500,000, the EEW was 1420 g/eq. and the refractive index was 1.488.

### Processing Aid 2

An 8-liter reactor equipped with a stirrer was charged with 0.5 part of sodium dioctyl sulfosuccinate (emulsifier) and 0.1 part of potassium persulfate (polymerization initiator) that were previously dissolved in water, and thereto was further added water, so that the total amount of water became 200 parts. Oxygen was removed by introducing nitrogen gas into the reactor and it was heated to 70° C. with stirring. A monomer mixture (A) of 80 parts of methyl methacrylate (MMA) was added dropwise at a rate of about 16 parts per hour. After the completion of the addition, a monomer mixture (B) of 20 parts of MMA was added dropwise at a rate of about 16 parts per hour. After the completion of the addition, the temperature was maintained at 70° C. for 60 minutes and then cooled to yield a latex.

The polymerization conversion was 99.5%. The obtained latex was coagulated with an aqueous solution of calcium chloride, heat-treated by raising the temperature up to 95° C., and dehydrated by means of a centrifugal dehydrator to give a dehydrated cake of a polymer. The dehydrated cake was washed with water in an amount almost the same weight as that of the polymer and then dried at 50° C. for 24 hours by a concurrent flow drier to give the PROCESSING AID 2 in the form of a white powder. The weight average molecular weight, Mw, was 500,000. It has no functional group. The refractive index was 1.492.

### Processing Aid 3

An 8-liter reactor equipped with a stirrer was charged with 0.5 part of sodium dioctyl sulfosuccinate (emulsifier) and 0.003 part of potassium persulfate (polymerization initiator) that were previously dissolved in water, and thereto was further added water, so that the total amount of water became 200 parts. Oxygen was removed by introducing nitrogen gas into the reactor and it was heated to 70° C. with stirring. A monomer mixture (A) of 49.2 parts of methyl methacrylate (MMA) and 0.8 parts of glycidyl methacrylate (GMA) was added dropwise at a rate of about 50 parts per hour. After the completion of the addition, 0.001 part of potassium persulfate was added to the reactor and a monomer mixture (B) of 34.44 parts of MMA and 0.56 parts of GMA was added dropwise at a rate of about 20 parts per hour. After the completion of the addition, the temperature was maintained at 70° C. for 30 minutes. Then, 0.05 part of potassium persulfate was added to the reactor and a monomer mixture (C) of 14.76 parts of MMA and 0.24 parts of GMA was added dropwise at a rate of about 35 parts per hour. After the completion of the addition, the temperature was maintained at 70° C. for 60 minutes and then cooled to yield a latex.

The polymerization conversion was 99.5%. The obtained latex was coagulated with an aqueous solution of calcium chloride, heat-treated by raising the temperature up to 95° C., and dehydrated by means of a centrifugal dehydrator to give a dehydrated cake of a polymer. The dehydrated cake was washed with water in an amount almost the same weight as that of the polymer and, then, dried at 50° C. for 24 hours by a concurrent flow drier to give the PROCESSING AID 3 in the form of a white powder. The weight average molecular weight, Mw, was 3,000,000. The EEW was 8875 g/eq. The refractive index was 1.491.

### Processing Aid 4

An 8-liter reactor equipped with a stirrer was charged with 0.9 part of sodium dioctyl sulfosuccinate (emulsifier) and 0.003 part of potassium persulfate (polymerization initiator) that were previously dissolved in water, and thereto was further added water, so that the total amount of water became 200 parts. Oxygen was removed by introducing nitrogen gas into the reactor and it was heated to 70° C. with stirring. A monomer mixture (A) of 40 parts of methyl methacrylate (MMA) and 10 parts of butyl acrylate (BA) was added dropwise at a rate of about 50 parts per hour. After the completion of the addition, 0.001 part of potassium persulfate was added to the reactor and a monomer mixture (B) of 30 parts of MMA and 5 parts of BA was added dropwise at a rate of about 20 parts per hour. After the completion of the addition, the temperature was maintained at 70° C. for 30 minutes. Then 0.05 part of potassium persulfate was added to the reactor and a monomer mixture (C) of 9 parts of MMA and 6 parts of BA was added dropwise at a rate of about 35 parts per hour. After the completion of the addition, the temperature was maintained at 70° C. for 60 minutes and then cooled to yield a latex.

The polymerization conversion was 99.5%. The obtained latex was coagulated with an aqueous solution of calcium chloride, heat-treated by raising the temperature up to 95° C., and dehydrated by means of a centrifugal dehydrator to give a dehydrated cake of a polymer. The dehydrated cake was washed with water in an amount almost the same weight as that of the polymer and then dried at 50° C. for 24 hours by a concurrent flow drier to give the PROCESSING AID 4 in the form of a white powder. The weight average molecular weight, Mw, was 4,000,000. It has no functional group. The refractive index was 1.486.

### Processing Aid 5

An 8-liter reactor equipped with a stirrer was charged with 0.9 part of sodium dioctyl sulfosuccinate (emulsifier) and 0.003 part of potassium persulfate (polymerization initiator) that were previously dissolved in water, and thereto was further added water, so that the total amount of water became 200 parts. Oxygen was removed by introducing nitrogen gas into the reactor and it was heated to 70° C. with stirring. A monomer mixture (A) of 40 parts of methyl methacrylate (MMA), 10 parts of butyl acrylate (BA) and 0.001 part of Triallyl isocyanurate (TAIC) was added dropwise at a rate of about 50 parts per hour. After the completion of the addition, 0.001 part of potassium persulfate was added to the reactor and a monomer mixture (B) of 30 parts of MMA and 5 parts of BA was added dropwise at a rate of about 20 parts per hour. After the completion of the addition, the temperature was maintained at 70° C. for 30 minutes. Then 0.05 part of potassium persulfate was added to the reactor and a monomer mixture (C) of 9 parts of MMA and 6 parts of BA was added dropwise at a rate of about 35 parts per hour. After the completion of the addition, the temperature was maintained at 70° C. for 60 minutes and then cooled to yield a latex.

The polymerization conversion was 99.5%. The obtained latex was coagulated with an aqueous solution of calcium chloride, heat-treated by raising the temperature up to 95° C., and dehydrated by means of a centrifugal dehydrator to give a dehydrated cake of a polymer. The dehydrated cake was washed with water in an amount almost the same weight as that of the polymer and then dried at 50° C. for 24 hours by a concurrent flow drier to give the PROCESSING AID 5 in the form of a white powder. The weight average molecular weight, Mw, was 4,000,000. It has no functional group. The refractive index was 1.486.

### Example 1

A biodegradable polymer composition was prepared by mixing 75 wt % of cellulose acetate, 24% of TEC as a biodegradable matrix polymer, and 1% of PROCESSING AID 1, which is a copolymer produced from a mixture containing 90 wt % methyl methacrylate and 10 wt % glycidyl methacrylate. The weight average molecular weight of the processing aid was 500,000 g/mol and EEW was 1420 eq/g. The mixing was conducted using a twin-screw extruder operated at 230° C. The biodegradable polymer composition was dried for four hours at 60° C. in a dry-air dryer. The sheet with 0.7 mm thickness was made by sheet extrusion using Brabender at 230° C. The injection-molded specimens (100 mm×13 mm×0.7 mm) were prepared for elongation test.

### Example 2

A biodegradable polymer composition was prepared as described in EXAMPLE 1, except the PROCESSING AID 1 was replaced by 1% of PROCESSING AID 4, which is methyl methacrylate having a weight average molecular weight of 4,000,000 g/mol.

### Example 3

A biodegradable polymer composition was prepared by mixing 99 wt % of polylactic acid (PLA) as a biodegradable matrix polymer and 1% of PROCESSING AID 1 as described in EXAMPLE 1. The mixing was conducted using a twin-screw extruder operated at 210° C. The biodegradable polymer composition was dried for four hours at 60° C. in a dry-air dryer. It was injection molded under the conditions of 210° C. of injection unit and 40° C. of mold by Xplore micro injection molder. The injection-molded specimens (¢ 25.4 mm×3 mm) were cut into the quarter size for DMA measurement.

### Example 4

A biodegradable polymer composition was prepared by mixing 99 wt % of PLA as a biodegradable matrix polymer and 1% of PROCESSING AID 3, which is a copolymer produced from a mixture containing 98.4 wt % of methyl methacrylate and 1.6 wt % of glycidyl methacrylate. The weight average molecular weight of the processing aid was 3,000,000 g/mol and EEW of 8875 g/eq.

### Example 5

A biodegradable polymer composition was prepared by mixing 95 wt % of PLA as a biodegradable matrix polymer and 5% of PROCESSING AID 2, which is a polymer produced from 100 wt % of methyl methacrylate. The weight average molecular weight of the processing aid was 500,000 g/mol.

### Example 6

A biodegradable polymer composition was prepared by mixing 99 wt % of PHBH as a biodegradable matrix polymer and 1% of PROCESSING AID 1 as described in EXAMPLE 1. The mixing was conducted using a twin-screw extruder operated at 160° C. The biodegradable polymer composition was dried for three hours at 80° C. in a dry-air dryer. It was injection molded under the conditions of 160° C. of injection unit and 40° C. of mold by Xplore micro injection molder. The injection-molded specimens (ϕ 25.4 mm×3 mm) were cut into the quarter size for DMA measurement.

### Example 7

A biodegradable polymer composition was prepared as described in EXAMPLE 1, except the PROCESSING AID 1 was replaced by 1% of PROCESSING AID 5, which is methyl methacrylate having a weight average molecular weight of 4,000,000 g/mol.

### Reference Example 1

The cellulose acetate used in EXAMPLE 1 was used as the baseline cellulose polymer composition.

### Reference Example 2

The PLA used in EXAMPLE 3 was used as the baseline biodegradable polyester composition.

### Reference Example 3

The PHBH used in EXAMPLE 6 was used as the baseline biodegradable polyester composition.

### Evaluation—Maximum Tensile Elongation

A maximum tensile elongation refers to the ratio of difference between the final length of the specimen (or the length of the specimen under tensile force at break) and the initial length of the specimen, on the one hand, and the initial length of the specimen, on the other hand. The maximum tensile elongation may be determined by the following formula:

$$Maximum tensile elongation ( \% ) = \frac{( {L}_{f} - {L}_{i} )}{{L}_{i}} \times 100$$

where L_{f} is the final length of the specimen, and Lᵢ is the initial length of the specimen.

The biodegradable polymer compositions of EXAMPLES 1 and 2 and the baseline composition of REFERENCE EXAMPLE 1 were formed into a tensile test specimen, and a tensile test was conducted at a test temperature of 165° C. and a test speed of 1,000 mm/min. The maximum tensile elongation of EXAMPLES 1 and 2 and REFERENCE EXAMPLE 1 are shown in Table 1. As shown in Table 1, the maximum tensile elongation values of EXAMPLES 1 and 2, which contain the processing aid, are substantially higher than that of the baseline composition of REFERENCE EXAMPLE 1. Such improvement in maximum tensile elongation may provide improved processability and formability of biodegradable polymer articles. A higher maximum tensile elongation may allow the composition to elongate without breakage during the forming process, such as the thermoforming process, which may elongate the composition at a substantially high rate, such as 1,000 mm/min.

### Evaluation-Optical Properties

The biodegradable polymer composition of EXAMPLES 1 and 2 and the baseline composition of REFERENCE EXAMPLE were evaluated to obtain their optical properties including Yellow Index (YI) values and haze values. EXAMPLES 1 and 2 and REFERENCE EXAMPLE were formed into a 0.7 mm thick sheet, and the yellow index values and haze values were measured using UltraScan VIS from HunterLab. The results are shown in Table 1.

TABLE 1

| | EXAMPLE | EXAMPLE | EXAMPLE | REFERENCE |
|---|---|---|---|---|
| | 1 | 2 | 7 | EXAMPLE 1 |
| Maximum | 212% | 235% | 245% | 162% |
| tensile | | | | |
| elongation | | | | |
| (%) | | | | |
| Yellow | 1.68 | N/A | N/A | 1.31 |
| Index | | | | |
| Haze | 7.4% | 70% | N/A | 6.0% |

As illustrated in Table 1, the YI and haze values of EXAMPLE 1 and REFERENCE EXAMPLE 1 are similar. Combined together, the test results indicate that addition of the processing aid provides improved mechanical properties, such as maximum tensile elongation, without negatively affecting the optical properties of the composition. Such characteristics are desirable for applications including transparent biodegradable polymer articles, such as clear disposable cups, because improvement in the formability and processability may be obtained without sacrificing the required optical properties. In particular, obtaining such mechanical and optical properties by adding 1% or less of the processing aid would be desirable because a biodegradable matrix polymer containing 1% or less of non-biodegradable additives is exempt from biodegradation testing to confirm its biodegradability.

EXAMPLE 2 showed high haze, but significant improvement of elongation property. Compositions having this haze may be suitable for opaque articles such as food trays.

The biodegradable polymer composition of EXAMPLE 7 was formed into a tensile test specimen and tensile test was conducted as described previously for EXAMPLES 1-2 and REFERENCE EXAMPLE 1 to obtain a maximum tensile elongation. The maximum tensile elongation was 245% which is higher than that of EXAMPLE 2. The small addition of crosslinker like TAIC into the polymer chain may have increased the entanglement with the biodegradable polymer, leading to the high elongation.

### Evaluation-Melt Strength and Rheological Properties

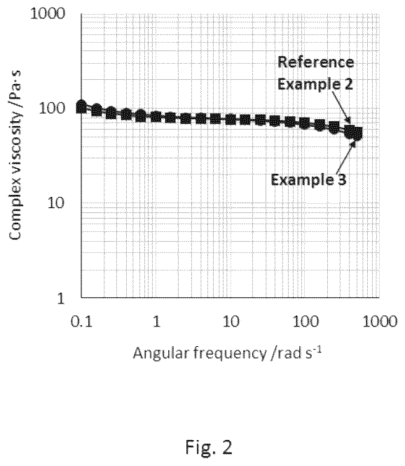

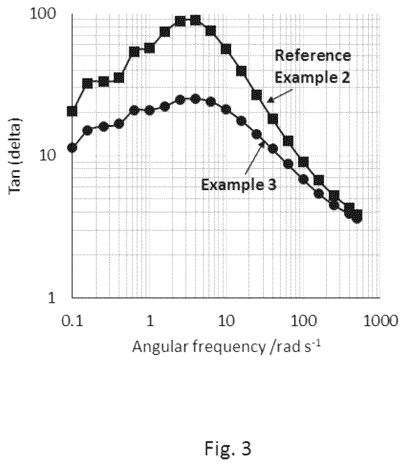

The biodegradable polymer compositions of EXAMPLES 3 and 4 and the baseline composition of REFERENCE EXAMPLE 2 were evaluated for their rheological characteristics, including complex viscosity and tan δ. The evaluation was conducted using a parallel plate rheometer having 25 mm plate diameter at a temperature of 210° C., and an angular frequency was varied from 0.1 rad/s to 500 rad/s. FIGS. 2 and 3 show the complex viscosity and tan δ values of EXAMPLE 3 and REFERENCE EXAMPLE 2 at various angular frequencies, respectively. FIG. 2 shows that the composition of EXAMPLE 3 and REFERENCE EXAMPLE 2 provide identical or very similar complex viscosity in the angular frequency range of 0.1 to 500 rad/s, while FIG. 3 shows that tan δ values of EXAMPLE 3 are substantially lower than those of REFERENCE EXAMPLE 2. The above test results show that the addition of processing aid improves the melt strength of the composition, as indicated by lower tan δ values, without increasing the complex viscosity of the composition, which would negatively affect the processability of the composition.

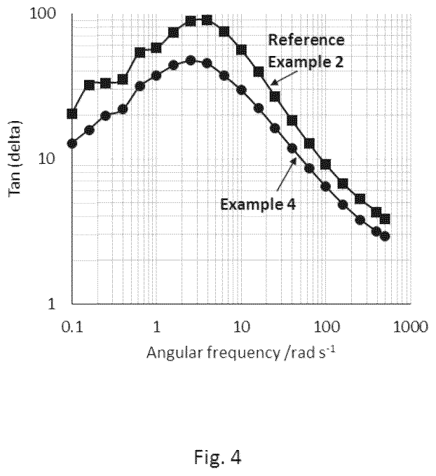

In addition, tan δ values of EXAMPLE 4 and REFERENCE EXAMPLE 2 at various angular frequencies are shown in FIG. 4. Similar to EXAMPLE 3, tan δ values of EXAMPLE 4 are substantially lower than those of REFERENCE EXAMPLE 2, further confirming that the processing aid helps to improve the melt strength of the biodegradable polymer composition.

The biodegradable polymer compositions of EXAMPLE 5 showed 600% of tan δ reduction against REFERENCE EXAMPLE 2.

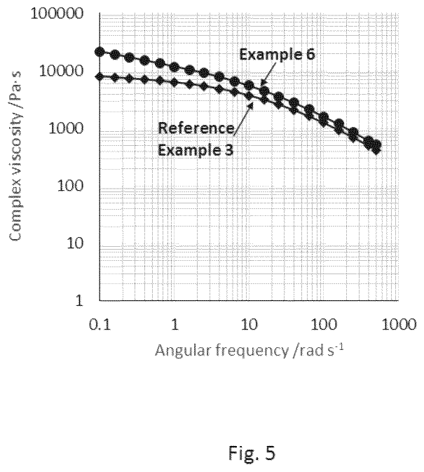

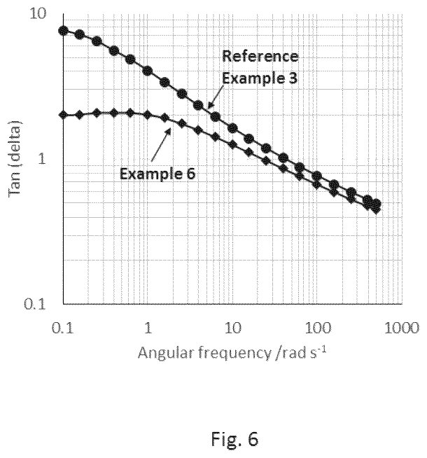

The biodegradable polymer compositions of EXAMPLE 6 and the baseline composition of REFERENCE EXAMPLE 3 were evaluated for their rheological characteristics, including complex viscosity and tan δ. The evaluation was conducted using a parallel plate rheometer having 25 mm plate diameter at a temperature of 160° C., and an angular frequency was varied from 0.1 rad/s to 500 rad/s. The results are shown in FIGS. 5 and 6. FIG. 6 shows that tan δ values of EXAMPLE 6 are substantially lower than those of REFERENCE EXAMPLE 3. The result indicate that the addition of processing aid improves the melt strength of the composition.

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims. In the claims, means-plus-function clauses are intended to cover the structures described herein as performing the recited function and not only structural equivalents, but also equivalent structures. Thus, although a nail and a screw may not be structural equivalents in that a nail employs a cylindrical surface to secure wooden parts together, whereas a screw employs a helical surface, in the environment of fastening wooden parts, a nail and a screw may be equivalent structures. It is the express intention of the applicant not to invoke 35 U.S.C. § 112 (f) for any limitations of any of the claims herein, except for those in which the claim expressly uses the words ‘means for’ together with an associated function.

1. A biodegradable polymer composition, comprising:
a biodegradable matrix polymer; and
0.1 to 5 wt. % of a processing aid having a weight average molecular weight (Mw) of at least 20,000 g/mol,
wherein:
the processing aid is a reaction product of an acrylate monomer and, optionally, at least one copolymerizable monomer;
an amount of the acrylate monomer in the processing aid ranges from 50 wt % to 100 wt %; and
an amount of the at least one copolymerizable monomer in the processing aid ranges from 0 wt % to 50 wt %.

2. The biodegradable polymer composition of claim 1, further comprising a plasticizer.

3. The biodegradable polymer composition of claim 1, wherein the acrylate monomer is a methyl methacrylate.

4. The biodegradable polymer composition of claim 1, wherein the at least one copolymerizable monomer is one or more selected from the group consisting of a (meth)acrylate monomer, a styrene monomer, an alpha methyl styrene monomer, an acrylonitrile monomer, a glycidyl methacrylate monomer, and a (meth)acrylic acid monomer.

5. The biodegradable polymer composition of claim 1, wherein the at least one copolymerizable monomer is a functional monomer.

6. The biodegradable polymer composition of claim 5, wherein the functional monomer comprises an epoxy group.

7. The biodegradable polymer composition of claim 5, wherein the functional monomer is glycidyl methacrylate.

8. The biodegradable polymer composition of claim 7, wherein an amount of glycidyl methacrylate in the processing aid ranges from 1 wt % to 30 wt %.

9. The biodegradable polymer composition of claim 6, wherein an epoxy equivalent weight of the processing aid ranges from 400 to 15,000 g/eq.

10. The biodegradable polymer composition of claim 1, wherein the biodegradable matrix polymer comprises cellulose.

11. The biodegradable polymer composition of claim 1, wherein the biodegradable matrix polymer comprises one or more cellulose polymers selected from the group consisting of cellulose acetate, cellulose acetate propionate, and cellulose acetate butyrate.

12. The biodegradable polymer composition of claim 3, wherein the processing aid has a refractive index (RI) of 1.45 to 1.50 at 25° C.

13. The biodegradable polymer composition of claim 1, wherein the biodegradable matrix polymer comprises a biodegradable polyester.

14. The biodegradable polymer composition of claim 1, wherein the biodegradable matrix polymer comprises one or more biodegradable polyester selected from a group consisting of polylactic acid, polybutylene adipate terephthalate, polyhydroxyalkanoate, and poly-(3-hydroxybutyrate-co-3-hydroxyhexanoate).

15. A biodegradable polymer article comprising the biodegradable polymer composition of claim 1.

16. The biodegradable polymer article of claim 15 comprising a sheet, a film, a foam, a rod, a profile sheet, a co-extruded sheet, a profile capstock, or a co-extruded capstock.

17. A method comprising:
mixing a biodegradable matrix polymer with 0.1 to 5 wt. % of a processing aid, having a weight average molecular weight (Mw) of at least 20,000 g/mol above melting temperatures of both the biodegradable matrix polymer and the processing aid, to produce a biodegradable polymer composition,
wherein:
the processing aid is a reaction product of an acrylate monomer and, optionally, at least one copolymerizable monomer;
an amount of the acrylate monomer in the processing aid ranges from 50 wt % to 100 wt %; and
an amount of the at least one copolymerizable monomer in the processing aid ranges from 0 wt % to 50 wt %.

18. The method of claim 17, further comprising forming a biodegradable polymer article from the biodegradable polymer composition.

19. The method of claim 18, wherein the forming comprises at least one process selected form the group consisting of extrusion, co-extrusion, injection molding, compression molding, film extrusion, and blow molding.
